(19) United States
(12) Patent Application Publication
(10) Pub. No.: US 2026/0020611 A1
(43) Pub. Date: Jan. 22, 2026

(54) AEROSOL PROVISION DEVICE

(71) Applicant: NICOVENTURES TRADING LIMITED, London (GB)

(72) Inventors: Mark POTTER, London (GB); Zhihuang XIAO, London (GB); Richard HAINES, London (GB)

(21) Appl. No.: 18/996,081

(22) PCT Filed: Jul. 17, 2023
(86) PCT No.: PCT/EP2023/069783

§ 371 Date: Jan. 17, 2025

(30) Foreign Application Priority Data
Jul. 21, 2022 (GB) 2210701.5

(51) Int. Cl. A24F 40/46; H05B 3/54

(52) U.S. Cl. CPC A24F 40/46; H05B 3/54; H05B 2203/007

(57) ABSTRACT

An aerosol provision device for generating aerosol from an aerosol-generating material includes a body defining a heating zone configured to receive at least a portion of an article having aerosol-generating material. The body includes a first portion having a first heating element and a second body portion having a second heating element. The first body portion includes a cavity defining at least a portion of the heating zone, and the first and second body portions are movable between an unclamped position in which the first and second body portions are at least partially separated, and a clamped position in which the first and second body portions are brought into abutment with each other.

### RELATED APPLICATIONS

The present application is a National Phase entry of PCT Application No. PCT/EP2023/069783 filed Jul. 17, 2023, which claims priority to GB Application No. 2210701.5 filed Jul. 21, 2022, each of which is hereby incorporated by reference in their entirety.

### TECHNICAL FIELD

The present invention relates to an aerosol provision device. The present invention also relates to an aerosol provision system comprising an aerosol provision device and an article comprising aerosol generating material.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

In accordance with some embodiments described herein, there is provided an aerosol provision device for generating aerosol from an aerosol-generating material, the device comprising a body defining a heating zone configured to receive at least a portion of an article comprising aerosol-generating material, the body comprising a first body portion having a first heating element and a second body portion having a second heating element; wherein the first body portion comprises a cavity defining at least a portion of the heating zone, and wherein the first and second body portions are movable between an unclamped position in which the first and second body portions are at least partially separated, and a clamped position in which the first and second body portions are brought into abutment with each other.

The cavity may be a first cavity and the second body portion may comprise a second cavity defining at least a portion of the heating zone.

The first body may define a first heating surface. The first heating surface may be concave. The concave first heating surface may define the cavity. The first heating element may form the first heating surface.

The second body may define a second heating surface. The second heating surface may be concave. The second heating element may form the second heating surface.

The first and second heating elements may define a cylindrical chamber in the clamped position. The first and second concave heating surfaces may together define the cylindrical chamber. In the clamped position, the first and second body portions may be arranged to be free from compressing at least part of an article received in the heating zone.

The heating zone may define a longitudinal axis along which at least a portion of an article comprising aerosol-generating material extends in the heating zone. The first and second body portions may be at least partially separable along a longitudinal plane extending in the direction of the longitudinal axis.

The first and second body portions may be pivotable about a pivot axis.

The pivot axis may extend perpendicular to the longitudinal axis. The pivot axis may extend parallel to the longitudinal axis.

The first and second body portions may slide relative to each other along a slide axis. The slide axis may extend perpendicular to the longitudinal axis. The slide axis may extend parallel to the longitudinal axis.

The body may comprise an opening from which at least a portion of an article may be arranged to protrude from the body. The opening may be defined by the first body portion and the second body portion. The opening may be defined by a rim.

In the clamped position, the first and second heating surfaces may evenly contact an exterior surface of the article.

The article may be inserted into the heating zone when the first and second body portions are in the unclamped position.

The first and second body portions may be arranged to frictionally restrain an article when the first and second body portions are in the clamped position. The first and second body portions may be arranged to frictionally restrain an article when the first and second body portions are in the clamped position.

The first and second heating elements may comprise a resistive heater. The first and second heating elements may comprise a ceramic heater. The first and second heating elements may comprise an inductive heater.

The first and second heating elements may comprise a curved surface.

The device may comprise an attachment arrangement to hold the first and second body portions in the clamped position.

The body may comprise a heating chamber defining the heating zone. The heating zone may be at least partially formed by the or each cavity. The diameter of the heating chamber in a clamped position may be equal to that of the diameter of an article arranged to be received in the heating chamber.

In use, the user may separate the first and second body portions to insert the article, and then bring the first and second body portions back into contact with each other to hold the article.

In the clamped position, the first and second heating elements may be in electrical contact with one another.

In accordance with some embodiments described herein, there is provided an aerosol provision device for generating aerosol from an aerosol-generating material, the device comprising a first resiliently deformable heating element and a second resiliently deformable heating element, a heating zone defined between the first and second heating elements, configured to receive at least a portion of an article comprising aerosol-generating material, wherein the first and second heating elements are moveable relative to each other between an open position in which the article is inserted between the heating elements, and a closed position in which the first and second heating elements deform around the article to contact an exterior surface of the article.

In accordance with some embodiments described herein, there is provided an aerosol provision system comprising the aerosol provision device as described in any of the above, and an article comprising aerosol generating material, the article configured for at least partial receipt in the heating chamber, such that in use, the article is in contact with the heating elements.

The article may be held within the heating chamber by the first and second body portions.

The article may have an external diameter equal to the diameter of the heating chamber.

The article may be inserted axially into the heating chamber.

### BRIEF DESCRIPTION OF THE DRAWINGS

Embodiments of the invention will now be described, by way of example only, with reference to accompanying drawings, in which:

FIG. 1 shows a perspective view of an aerosol provision device in a clamped position;

FIG. 2 shows the aerosol provision device of FIG. 1 in an unclamped position;

FIG. 3 shows a perspective view of another aerosol provision device in an unclamped position;

FIG. 4 shows a perspective view of another aerosol provision device in an unclamped position;

FIGS. 5a and 5b show an aerosol provision device in an unclamped and clamped position respectively;

FIG. 6a shows a perspective view of another aerosol provision device in an unclamped position; and

FIG. 6b shows a perspective view of part of the aerosol provision device of FIG. 6a with a deformed heating element in view of an article being received thereon, but with the article omitted from view.

### DETAILED DESCRIPTION

As used herein, the term “aerosol-generating material” is a material that is capable of generating aerosol, for example when heated, irradiated or energized in any other way. Aerosol-generating material may, for example, be in the form of a solid, liquid or gel which may or may not contain an active substance and/or flavorants. Aerosol-generating material may include any plant based material, such as tobacco-containing material and may, for example, include one or more of tobacco, tobacco derivatives, expanded tobacco, reconstituted tobacco or tobacco substitutes. Aerosol-generating material also may include other, non-tobacco, products, which, depending on the product, may or may not contain nicotine. Aerosol-generating material may for example be in the form of a solid, a liquid, a gel, a wax or the like. Aerosol-generating material may for example also be a combination or a blend of materials. Aerosol-generating material may also be known as “smokable material”.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In some embodiments, the aerosol-generating material is substantially tobacco free.

The aerosol-generating material may comprise or be an “amorphous solid”. The amorphous solid may be a “monolithic solid”. In some embodiments, the amorphous solid may be a dried gel. The amorphous solid is a solid material that may retain some fluid, such as liquid, within it. In some embodiments, the aerosol-generating material may, for example, comprise from about 50 wt %, 60 wt% or 70 wt % of amorphous solid, to about 90 wt %, 95 wt% or 100 wt % of amorphous solid.

The aerosol-generating material may comprise an aerosol-generating film. The aerosol-generating film may comprise or be a sheet, which may optionally be shredded to form a shredded sheet. The aerosol-generating sheet or shredded sheet may be substantially tobacco free.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energized so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

An aerosol generating device can receive an article comprising aerosol generating material for heating. An “article” in this context is a component that includes or contains in use the aerosol generating material, which is heated to volatilize the aerosol generating material, and optionally other components in use. A user may insert the article into the aerosol generating device before it is heated to produce an aerosol, which the user subsequently inhales. The article may be, for example, of a predetermined or specific size that is configured to be placed within a heating chamber of the device which is sized to receive the article.

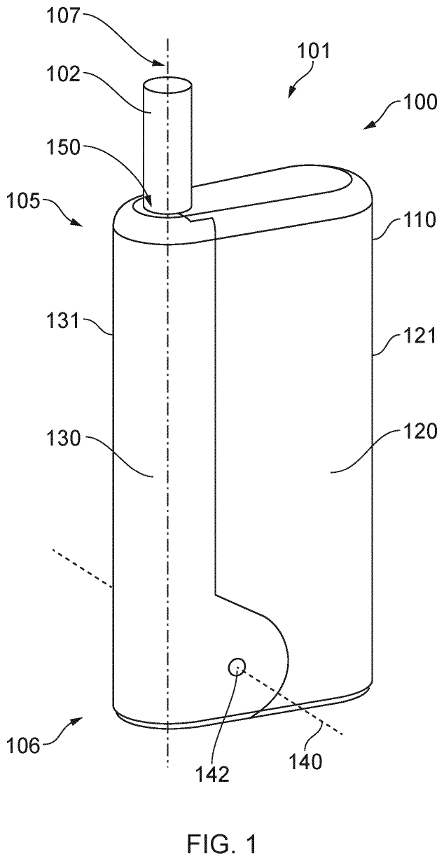

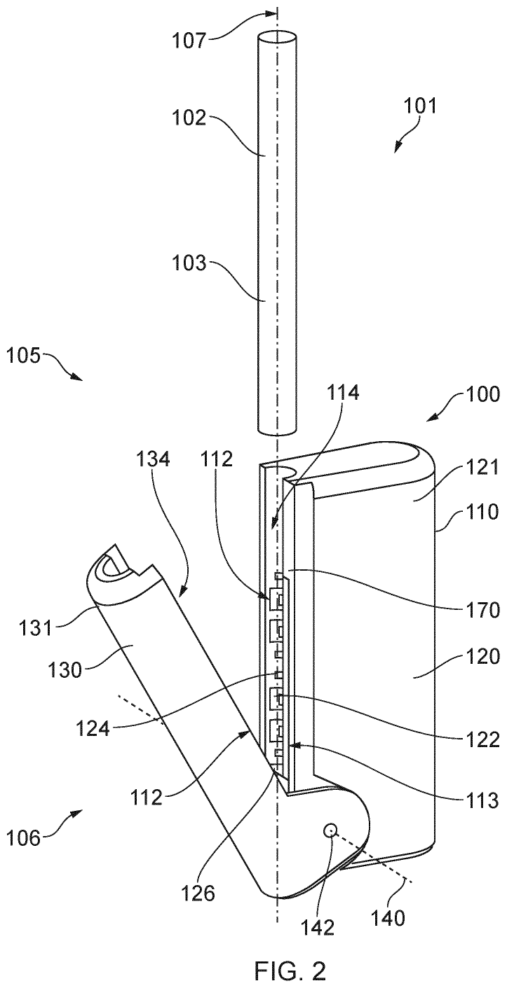

FIG. 1 shows an aerosol provision system 101. The system includes an aerosol provision device 100 for generating aerosol from aerosol generating material and an article 102 comprising the aerosol generating material. In FIG. 1, the device 100 is in a clamped position. FIG. 2 shows the device 100 in an unclamped position. The device 100 may be used to heat the replaceable article 102 comprising the aerosol generating material, to generate aerosol or other inhalable medium which is inhaled by a user of the device 100.

The device 100 comprises a body 110. The body 110 surrounds and houses various components of the device 100. An opening 150 is formed in one end of the body 110, from which an exposed portion of the article 102 protrudes. A portion of the article 102 is received by the body 110 for heating by an aerosol generator 111. In use, the article may be fully or partially inserted into a receptacle 114 within the body 110. The receptacle is defined between the opening 150 and a base 116 of the receptacle 114 (shown in FIG. 2). A heating zone 112 is defined by a portion of the receptacle 114. The heating zone 112 receives an article 102 which may be heated by one or more components of the aerosol generator 111. The aerosol generator 111 comprises a heating assembly 113.

The body comprises a first body portion 120 and a second body portion 130. The second body portion 130 is attached to the first body portion 120. The first body portion 120 comprises a first housing 121. The second body portion 130 comprises a second housing 131. It will be understood that the number of body portions may vary.

The device 100 may also include a user-operable control element (not shown), such as a button or switch, which operates the device 100 when pressed. For example, a user may turn on the device by operating the switch.

The body 110 has end surfaces of the device 100. The end of the device 100 closest to the opening 150 may be known as the proximal end (or mouth end) 105 of the device 100 because, in use, it is closest to the mouth of the user. In use, a user inserts an article 102 into the opening 150, operates the aerosol generator 111 to begin heating the aerosol generating material, and draws on the aerosol generated in the device 100. This causes aerosol to flow through the device 100 along a flow path towards the proximal end 105 of the device 100.

The other end of the device furthest away from the opening 150 may be known as the distal end 106 of the device 100 because, in use, it is the end furthest away from the mouth of the user. As a user draws on the aerosol generated in the device, the aerosol flows in a direction towards the proximal end 105 of the device 100. The terms proximal and distal as applied to features of the device 100 will be described by reference to the relative positioning of such features with respect to each other in a proximal-distal direction along a longitudinal axis 107.

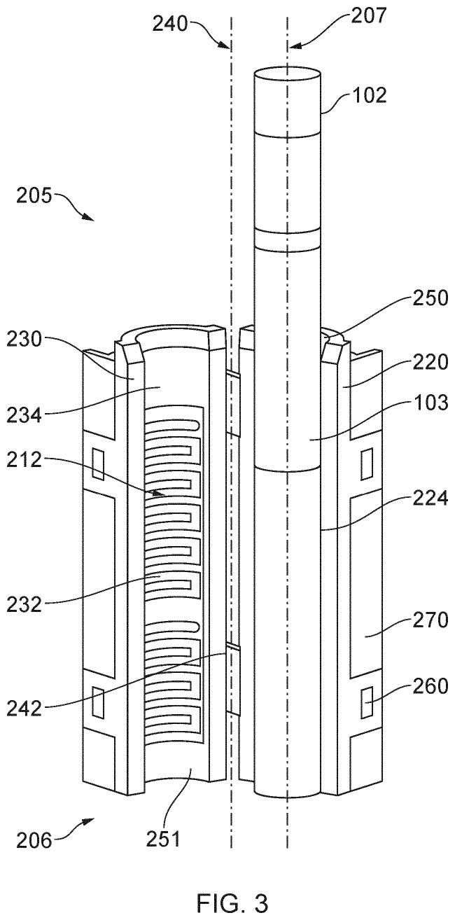

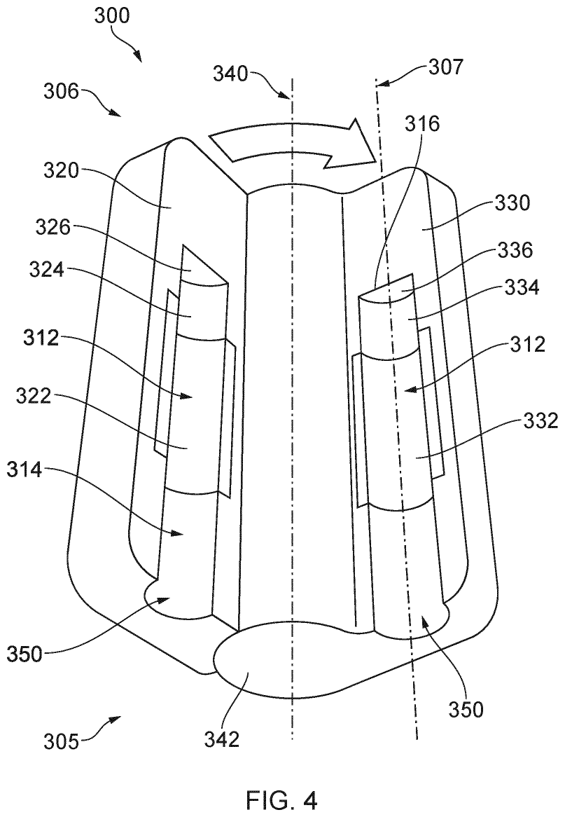

The first and second body portions 120, 130 are moveably attached to one another. In FIGS. 1 and 2, the second body portion 130 pivots relative to the first body portion 120. The relative motion between the first and second body portions may be linear or rotational. The second body portion 130 pivots around pivot axis 140 by means of a hinge 142. The hinge 142 is at one end of the device. The hinge 142 is at the distal end 105 of the device 100. The first and second body portions 120, 130 are connected to each other by the hinge 142. The hinge 142 restricts the limits of the opening of the first and second body portions 120, 130. The hinge 142 may prevent the first and second body portions 120, 130 from being opened more than a predetermined angle. The pivot axis 140 is perpendicular to the longitudinal axis 107. The pivot axis may be parallel to the longitudinal axis, as described later and in FIGS. 3 and 4.

The first and second body portions 120, 130 are moveable relative to each other between a clamped and an unclamped position. In the unclamped position, the second body portion 130 is pivoted about the hinge 142 to pivot away from the first body portion 120. The first and second body portions 120, 130 are substantially separated from each other.

The first body portion 120 comprises a first cavity 124. The first body portion 120 comprises a first heating element 122. The first heating element 122 defines at least part of the first cavity 124. The first heating element 122 comprises a first heating surface. The first heating surface may define at least part of the first cavity 124. The first heating element 122 may define part or all of the first cavity 124. The first cavity 124 is concave. The first heating surface may be concave.

The first cavity 124 receives a portion of the article 102 in use. The first heating element 122 has a concave surface which is in contact with the article 102. The first body portion 120 defining the first cavity 124 has an internal profile corresponding to a portion of the profile of the external surface 103 of the article 102. The first cavity 124 defines at least a portion of the heating zone 112. The first heating surface defines at least a portion of the heating zone 112. The first body portion 120 comprises a first base portion 126. The first base portion 126 defines a portion of the base 116 of the receptacle 114. The first base portion 126 defines a stop to limit insertion of the article 102 within the first cavity 124.

The second body portion 130 comprises a second cavity 134. The second body portion 130 comprises a heating element (obscured by the article). The second heating element comprises a second heating surface. The second heating element may define at least part of the second cavity 134. The second heating element may define part or all of the second cavity 134. The second cavity 134 is concave. The second heating surface may be concave.

The second cavity 134 receives a portion of the article 102 in use. The second heating element has a concave surface which is in contact with the article 102. The second cavity 134 has an internal profile corresponding to a portion of the profile of the external surface 103 of the article 102. The second cavity 134 defines at least a portion of the heating zone 112. The second heating surface defines at least a portion of the heating zone 112. The second body portion 130 comprises a second base portion 136. The second base portion 136 defines a portion of the base 116 of the receptacle 114. The second base portion 136 defines a stop to limit insertion of the article 102 within the second cavity 134.

The first and second cavities 124, 134 define the receptacle 114 in which the article 102 is received. The heating zone is defined in the receptacle 114. The heating zone may extend along part or all of the receptacle 114. The first and second base portions 126, 136 define the base 116 in the clamped condition. The receptacle 114 is defined radially between the first and second heating elements 122, and axially between the base 116 at the distal end 106 of the device 100 and the opening 150 at the proximal end 105 of the device 100. The first and second heating elements 122 form part of the heating assembly 113. The diameter of the receptacle 142 is equal to the diameter of the article 102. It will be understood that the configurations of the first and second body portions 120, 130 may differ.

In use, the user separates the first and second body portions 120, 130 to insert the article 102 axially into the device along the longitudinal axis 107. The article 102 is inserted into the device 100 at the proximal end 105. The first and second body portions 120, 130 are brought back into contact with each other to locate and restrain the article 102. In the clamped position, the article 102 is retained in the receptacle 114. The base 116 limits axial insertion of the article 102 into the receptacle 114. In the clamped condition, the article 102 is frictionally restrained in the receptacle 114.

The second body portion 130 is pivoted towards the first body portion 120 to move the device 100 from an unclamped position to a clamped position. In the unclamped position, the article 102 is received by the first cavity 124. In embodiments, the article 102 may be received by the second cavity 134. The second body portion 130 is pivoted around the pivot axis 140 by pivot element 142 into the clamped position. The pivot axis 140 is perpendicular to the longitudinal axis 107. The pivot element 142 is at the distal end of the device such that article 102 can be inserted into the proximal end 105 of the device 100 in the unclamped position.

The second body portion 130 is pivoted around the pivot axis 140 and brought into contact with the article 102. The second heating element is brought into contact with article 102. The first and second heating elements 122 are brought into abutment with the article 120. Such an arrangement aids to reduce or eliminate an air gap between the article and the first and second heating elements 122. The first and second heating elements 122 evenly contact an external surface 103 of the article 102. The base 116 limits axial movement of the article 102 in the unclamped position. The first and second body portions 120, 130 are in brought into contact when the device 100 is in the clamped position. The first and second body portions 120, 130 contact each in the clamped position to limit the diameter of the receptacle 114 and prevent further pivoting of the first and second body portions 120, 130. This ensure the first and second body portions 120, 130 are brought together without compressing the article 102.

In the clamped position, the article 102 is located within the first and second cavities 124, 134.

The article 102 is received by the first and second heating elements 124, 134. The external surface 103 of the article 102 is in contact with the first and second heating elements 124. The first and second heating elements 124, 134 define the receptacle 114 in the clamped position. The receptacle 114 defines a cylindrical heating chamber for receiving the article 102. The heating chamber extends from the proximal end 105 of the device towards the distal end 106 along the longitudinal axis 107. The heating chamber may extend partially through the body 110, being closed at the distal end 106 by the base 116.

In embodiments, the cylindrical cavity may by open at both the proximal and distal ends 105, 106 such that the cavity extends the length of the body 110 such that the article 102 is inserted fully or partially into the heating chamber. A portion of the heating chamber defines the heating zone 112. The first and second body portions 120, 130 together define an opening 150 in the device 100. The opening 150 is defined by a rim. The diameter of the heating chamber and the opening 150 in the clamped position is equal to that of the article 102. The concave first and second cavities 124, 134 are arranged to receive the external surface 103 of the article 102 without compressing any portion of the article 102. As used herein the term “compression” is used to indicate that any portion of the article significantly distorts from its initial uncompressed state. There is a predetermined substantive change to the shape or size of any portion of the article. It will be understood that by the clamping nature of the configuration some small/minimal compressive force will occur, both in general and due to slight tolerances in manufacture of the article. In a clamped but non-compressed state the article is held by the clamping action without any portion of the article significantly distorting from its initial unclamped state.

The concave first and second cavities 124, 134 evenly contact the external surface 103 of the article 102 to provide even heating of the article 102 free from compression of the aerosol generating material. In embodiments, the first and second cavities 124, 134 allow for a larger contact area between the first and second heating elements 122 and the article 102. This allows for good heat transfer between the first and second heating elements 122 and the article 102. The concave first and second cavities 124, 134 prevent compression of the article 102 in the clamped condition, while still providing a good contact area on the article 102 from the first and second heating elements 122. This provides improved airflow through the article 102 and aerosol generating material to allow for even heating throughout the article, providing even aerosol generation and delivery.

The first and second body portions 120, 130 may be held in the clamped position by an attachment arrangement 170. The attachment arrangement 170 allows the first and second body portions 120, 130 to be releasably held together in the clamped position. In embodiments, the attachment arrangement may comprise a magnet, clip, latch, or locking mechanism. In the clamped position, the article 102 protrudes from the opening 150.

In the clamped position, the first and second heating elements 122 are in contact with the article 102 but do not compress the article. The first and second heating elements 122 are shaped to retain the article within the cylindrical chamber defined by the first and second cavities 124, 134. The article 102 is frictionally restrained in the heating zone by the first and second heating elements 122. The first and second heating elements 122 evenly contact the exterior surface 103 of the article 102.

The heating assembly 113 in this embodiment is a resistive-type heating system. The first and second heating elements 122 comprise resistive heating elements. In embodiments, other types of heating may be used, for example, inductive heating. The first and second heating elements 122 in embodiments may comprise ceramic heating elements. The first and second heating elements 122 define curved surfaces. The curved surfaces of the first and second heating elements 122 are contact surfaces. In the clamped position, the first and second heating elements 122 are in electrical contact with one another. The first and second body portions 120, 130 comprise electrical contacts which are brought together when the device 100 is brought into the clamped position.

An electronics assembly is in the body 110. The electronics assembly is housed in the first body portion 120 within the first housing 121. In embodiments, the second housing 122 may comprise part of the electronics assembly. The electronics assembly comprises a power source. The power source may be, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery. The battery is electrically coupled to the heating assembly to supply electrical power when required and under control of a controller to heat the aerosol generating material. The electronics assembly comprises an electronics module. The electronics module may comprise a printed circuit board assembly (PCBA). The PCBA may comprise, for example, a printed circuit board (PCB) that supports at least one controller, such as a processor, and memory. The PCB may also comprise one or more electrical tracks to electrically connect together various electronic components. The battery terminals may be electrically connected to the PCB so that power can be distributed throughout the device 100.

FIG. 3 shows an embodiment in which the pivot axis 240 is parallel to the longitudinal axis 207 of a device 200. The device 200 comprises substantially similar features to the device of FIGS. 1 and 2. Accordingly, a detailed description will be omitted and features discussed above are applicable to the embodiments described below.

The device 200 is shown in the unclamped position with the article 102 inserted into the first cavity of the first body portion 220. The first and second body portions 220, 230 are brought into contact to close the heating zone 112 and surround the article 102. The first body portion 220 defines a first cavity 224. The first body portion 220 comprises a first heating element (obscured by the article). The second body portion 230 defines a second cavity 234. The second body portion 230 comprises a second heating element 232.

The first and second cavities 234 form the heating zone 212. The first and second cavities 234 define a cylindrical chamber in which the article 102 received. The article 102 is inserted into the device 200 in the unclamped position. The article 102 is partially inserted into the first or second cavities 234 such that a portion of the article 102 protrudes from the opening 250. In embodiments, one of the body portions does not define a cavity. The first and second body portions 220, 230 are brought together into the clamped position by pivoting one or both of the first and second body portions 220, 230 around the pivot axis 240.

The hinge 242 attaches the first and second body portions 220, 230 and allows for the first and second body portions 220, 230 to pivot around the pivot axis 240. In the clamped position, the first and second body portions 220, 230 are in contact with one another. The first and second body portions are held together by attachment means 270. In the clamped position, the article 102 is held between the first and second heating elements 232. The exterior surface 103 of the article 102 is in contact with the first and second heating elements 232 such that a portion of the article 102 is held within the heating zone 212. The article 102 can be inserted laterally into the device 200. The first and second body portions define a cylindrical cavity in which the article 102 is at least partially received.

The heating zone 112 of the device 200 is defined between the opening 250 at the proximal end 205 and a base aperture 251. The opening 250 and the base aperture 251 defines a throughbore. Accordingly, the article protrudes from the device at both the proximal and distal ends of the device. Such an arrangement provides for air to flow directly into the article 102 from an external environment without passing in the device 200 itself. This helps provide an unrestricted airflow. This direct airflow allows for simple construction of the device 200. The article 102 is not axially restricted within the device 102 in the unclamped position and can be positioned within the heating zone 212 according to user preference. This allows for the article to be placed in different axial positions to provide different heating profiles of the article without adjusting operation of the heating assembly. In the clamped position, the article 102 is frictionally restrained in the heating zone 212.

FIG. 4 shows an embodiment in which the pivot axis 340 of a device 300 is parallel to the longitudinal axis 307. The device 300 comprises substantially similar features to the devices described above. Accordingly, a detailed description will be omitted and features discussed above are applicable to the embodiments described below.

The device 300 is shown without an article in the heating zone 212. The receptacle 314 is defined by first and second body portions 320 forming first and second cavities 324, 334. The receptacle 314 is closed at one end by first and second base portions 326, 336 defining a base 316. The receptacle has an opening 350. The first and second body portions 320, 330 are attached by the pivot element 342. The first and second body portions 320, 330 are brought together by the pivoting one or both of the first and second body portions 320, 330 around the pivot axis 340. The article is inserted laterally into one of the first or second cavities 324, 334 when the device is in the unclamped position. The first and second body portions 320, 330 are brought together into the clamped position such that both the first and second heating elements 322, 332 are brought into contact with the article. The article protrudes from the opening 350 in the proximal end 305 of the device 300. The base 316 allows for axial location of the article 102 when inserting it into one of the first or second cavities 324, 334. The base 316 locates the article 102 such that the article 102 is aligned within one of the first or second cavities 324, 334 in the unclamped position.

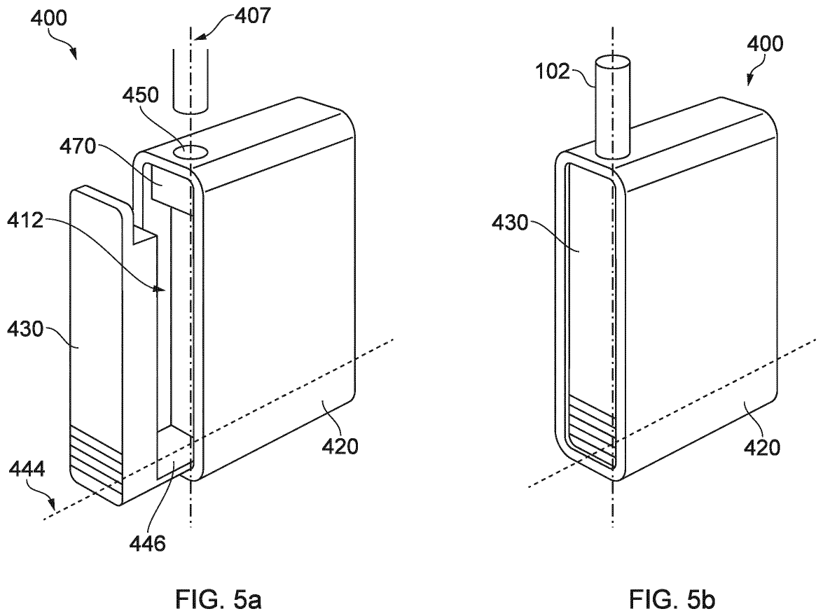

FIGS. 5a and 5b shows an embodiment in which a device 400 comprises first and second body portions 420, 430 moveable between clamped and unclamped positions in a linear motion. The device 400 comprises substantially similar features to the devices described above. Accordingly, a detailed description will be omitted and features discussed above are applicable to the embodiments described below.

FIG. 5a shows the device 400 in the unclamped position. FIG. 5b shows the device 400 in the clamped position. The article 102 is inserted through the opening 450 into the device 400 when the device is in the unclamped position. In the unclamped position, the second body portion 430 is substantially separated from the first body portion 420. In the unclamped position, the article 102 is inserted into the device 400 through the opening 450, the article being partially received by a first cavity in the first body portion 420. The first body portion 420 comprises a first heating element. The second body portion 430 comprises a second heating element. The second body portion 430 is brought into contact with the first body portion 430 by sliding the second body portion 430 towards and into the first body portion 420 along a slide axis 444. Slide element 446 allows for location of the second body portion 430 in the first body portion 420 and to retain the second body portion 430 along the slide axis 444 when moving between the clamped and unclamped positions. The slide axis 444 is perpendicular to the longitudinal axis 407. The slide axis may be parallel to the longitudinal axis 407. The article 102 is retained in the device 400 by the opening 450 to improve ease of insertion and location of the article when moving the first and second body portions 420, 430 between the unclamped and clamped positions.

In the clamped position, a heating zone is defined by a first cavity and the second cavity. The article 102 is received in the heating zone. The second cavity contacts the article 102 when the second body portion 430 is moved into the clamped position by sliding the second body portion 430 towards the first body portion 420 along the slide axis 444. An attachment means is present on the first body portion 420 to attach the first and second body portions 420, 430 in the clamped position.

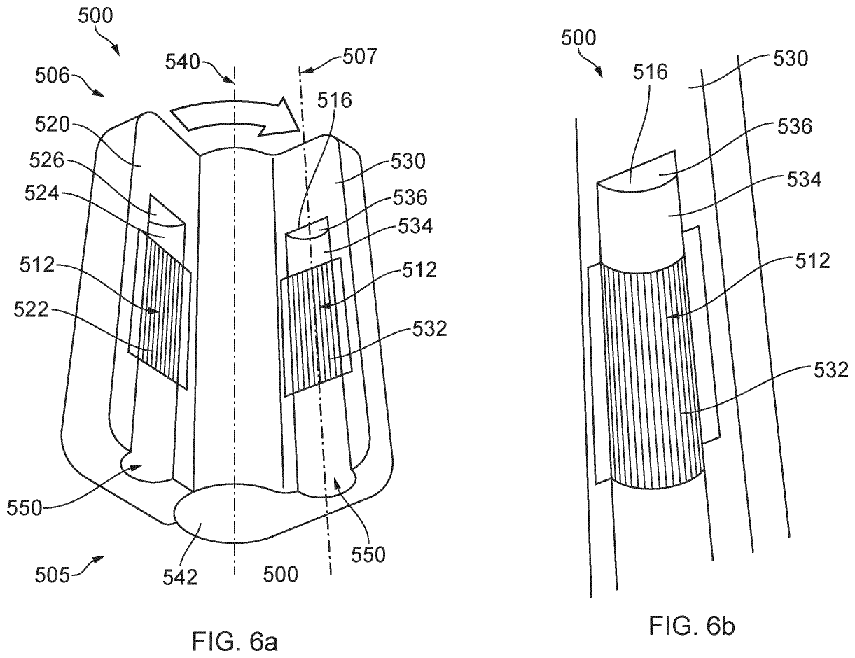

FIGS. 6a and 6b shows another aerosol provision device 500. FIG. 6b shows a perspective view of part of the aerosol provision device of FIG. 6a with a deformed heating element in view of an article being received thereon, but with the article omitted from view for clarity. The device 400 comprises substantially similar features to the devices described above. Accordingly, a detailed description will be omitted and features discussed above are applicable to the embodiments described below.

The device has a similar configuration to that of FIG. 4. Features described above with reference to the above embodiments are applicable to this device 500. However, in this arrangement the first and second heating elements 522, 532 are resiliently deformable. The first and second heating elements 522, 532 are biased to resiliently deform by the article acting on the heating elements 522, 522 when the article 102 is inserted into the cavities 524, 534 and the device moved into a clamped condition. The heating elements comprise a plurality of heating element portions linked by resilient members therebetween. Other deformable arrangements of the heating elements are envisaged. For example, the heating material may be deformable. The heating elements are therefore able to deform to the shape of the article. Such an arrangement maximises thermal contact area with the article. The heating zone 512 is greater in volume when an article 102 is inserted, than when an article 102 is not inserted. The first and second heating elements 522, 532 deform such that they surround the article 102 to evenly contact an exterior surface of the article. The deformable heating elements allow for consistent, even contact on the exterior surface of the article to provide even heating of the article without compressing the aerosol generating material. The first and second heating elements 522, 532 are resilient.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An aerosol provision device for generating aerosol from an aerosol-generating material, the device comprising:
a body defining a heating zone configured to receive at least a portion of an article comprising aerosol-generating material,
the body comprising a first body portion comprising a first heating element and a second body portion comprising a second heating element;
wherein the first body portion comprises a cavity defining at least a portion of the heating zone, and
wherein the first and second body portions are movable between an unclamped position in which the first and second body portions are at least partially separated, and a clamped position in which the first and second body portions are brought into abutment with each other.

2. The aerosol provision device of claim 1, wherein the cavity is a first cavity and the second body portion comprises a second cavity defining at least a portion of the heating zone.

3. The aerosol provision device of claim 1, wherein the first body defines a first heating surface.

4. The aerosol provision device of claim 3, wherein the first heating surface is concave.

5. The aerosol provision device of claim 1, wherein the second body defines a second heating surface.

6. The aerosol provision device of claim 5, wherein the second heating surface is concave.

7. The aerosol provision device of claim 1, wherein the first and second heating elements define a cylindrical chamber in the clamped condition.

8. The aerosol provision device of claim 1, wherein in the clamped condition the first and second body portions are arranged to be free from compressing at least part of an article comprising aerosol-generating material received in the heating zone.

9. The aerosol provision device of claim 1, wherein the first and second body portions are at least partially separable along a longitudinal plane extending in the direction of a longitudinal axis of the heating zone.

10. The aerosol provision device of claim 1, wherein the first and second body portions are pivotable about a pivot axis extending perpendicular to the longitudinal axis.

11. The aerosol provision device of claim 1, wherein the first and second body portions are pivotable about a pivot axis extending parallel to the longitudinal axis.

12. The aerosol provision device of claim 1, wherein the body comprises an opening from which at least a portion of an article is arranged to protrude from the body.

13. The aerosol provision device of claim 12, wherein the opening is defined by the first body portion and the second body portion.

14. The aerosol provision device of claim 1, wherein in the clamped position, the first and second heating surfaces evenly contact an exterior surface of the article.

15. The aerosol provision device of claim 1, wherein the article is frictionally restrained in the heating zone when the first and second body portions are in the clamped position.

16. An aerosol provision device for generating aerosol from an aerosol-generating material, the device comprising:
a first resiliently deformable heating element and a second resiliently deformable heating element,
a heating zone defined between the first and second heating elements, configured to receive at least a portion of an article comprising aerosol-generating material,
wherein the first and second heating elements are moveable relative to each other between an open position in which the article is inserted between the heating elements, and a closed position in which the first and second heating elements deform around the article to contact an exterior surface of the article.

17. An aerosol provision system comprising:
the aerosol provision device of claim 1, and
an article comprising aerosol generating material, the article configured for at least partial receipt in the heating chamber, such that in use, the article is in contact with the heating elements.

18. The aerosol provision system of claim 17, wherein the article is held within the heating chamber by the first and second body portions.

19. The aerosol provision system of claim 17, wherein the article has an external diameter equal to the diameter of the heating chamber.

20. The aerosol provision system of claim 17, wherein the article is inserted axially into the heating chamber.
